(19) United States
(12) Patent Application Publication
(10) Pub. No.: US 2013/0194083 A1
(43) Pub. Date: Aug. 1, 2013

(54) SYSTEM AND METHOD FOR DELIVERING HAPTIC FORCE FEEDBACK WITH CABLE AND MOVING CAPSTAN DRIVE MECHANISM

(71) Applicant: R. Bhavani Rao, Kerala (IN)

(72) Inventor: R. Bhavani Rao, Kerala (IN)

(73) Assignee: Amrita Vishwa Vidyapeetham, Kerala (IN)

(21) Appl. No.: 13/465,646

(22) Filed: May 7, 2012

(30) Foreign Application Priority Data
Oct. 18, 2011 (IN) 3082/CHE/2010

(51) Int. Cl. G08B 6/00

(52) U.S. Cl. CPC G08B 6/00
USPC 340/407.1

(57) ABSTRACT

The various embodiments of the present invention provide a system and method for delivering a haptic force feedback during a vocational tool operation. According to an embodiment, the system comprises a moving capstan drive mechanism connected to a holder and a motor. A sensor detects the rotation speed of a motor. A control circuit is connected to the sensor and to an information processor loaded with virtual reality environment software to provide a feedback force to the user, when the holder is displaced. The linear displacement of the holder is converted into a rotational movement of motor. The sensor outputs a signal based on the rotational speed of the motor to the control circuit to provide a haptic feedback force to a user and to provide a display, when the holder is displaced linearly by the user.

### PRIORITY

This U.S. utility patent application claims foreign priority, under 35 U.S.C. 119, to Indian Patent Application No.: 3082/CHE/2010, filed Oct. 18, 2011, all disclosures of which are incorporated by reference herein in their entirety.

### TECHNICAL FIELD

The present invention generally relates to a haptic device and particularly relates to a system and method for providing a vocational education and training using haptic force feedback. The present invention is more particularly related to a system and method of delivering haptic force feedback with a cable and moving capstan drive mechanism.

### BACKGROUND OF THE INVENTION

Haptic technology, or haptics, is a tactile feedback technology that takes advantage of a user's sense of touch by applying forces, vibrations, and/or motions to the user. Haptic devices (or haptic interfaces) are mechanical devices that mediate communication between the user and the computer. Haptic devices allow users to touch, feel and manipulate three-dimensional objects in virtual environments and tele-operated systems. As a user manipulates the end effector, grip, manipulandum or handle on a haptic device, position feedback sensor output is transmitted to an interface controller at very high rates. Here the information is processed to determine the position of the end effector. The position is then sent to the host computer running a supporting software application. If the supporting software determines that a reaction force is required, the host computer sends force feedback information to the device. Actuators (motors within the device) apply these forces based on mathematical models that simulate the desired sensations.

In the existing techniques, a capstan is mounted directly on the actuator shaft and does not move co-axial to motor shaft axis. The cable which acts as a torque-force transfer member is wound on the capstan and laid helically over a base of some diameter moves in a helical path when the capstan rotates. Since the cable travels in the helical path it is supported by an arc-shaped base which is placed in contact with the cable along its length, in order to maintain the cable at sufficient and constant tension.

In cases where this base for the cable cannot be provided due to spacing constraints, or in case where the base cannot be arc-shaped, the cable which tends to travel sideways and hence cannot be tensioned optimally. Optimal tension is required to keep the backlash zero and at the same time to maintain sufficient friction.

Hence there exists a need for a mechanism in order to prevent the sideways travel of the cable over the capstan by allowing for a translational travel of the capstan instead. There is also a need for a mechanism which prevents de-tensioning of the cable. Hence this eliminates the need for a complex/optimal tensioning mechanism for the cable.

The above mentioned shortcomings, disadvantages and problems are addressed herein, which will be understood by reading the following specification.

### OBJECTS OF THE INVENTION

A primary objective of the present invention is to provide a system and method for delivering a haptic force feedback using a cable and moving capstan drive mechanism.

Another objective of the present invention is to provide a system and method for delivering a haptic force feedback in which the cable and capstan drive mechanism rotates an actuator (motor) to provide kinesthetic force feedback.

Yet another objective of the present invention is to provide a system and method for delivering a haptic force feedback by preventing a slackening of the cable in the force-torque transfer in the absence of a solid supporting base for the cable.

Yet another objective of the present invention is to provide a system and method for delivering a haptic force feedback in which the haptic device actuator (motor) is rotated using a cable and moving capstan drive mechanism.

Yet another objective of the present invention is to provide a capstan which rotates as well as moves co-axially to motor.

Yet another object of the present invention is to provide a system and method for delivering a haptic force feedback with a moving capstan drive mechanism which converts a helical movement of a moving capstan into a rotary movement by eliminating a transfer of the linear movement (co-axial movement to motor) and rotates a haptic device to get a kinesthetic force feed back.

Yet another objective of the present invention is to provide a system and method for delivering a haptic force feedback with a moving capstan drive mechanism in which the moving capstan moves helically so that the moving capstan is rotated and as well as moved co-axial to the motor shaft to converts a linear movement of a tool handle in the handle and roll assembly into a rotation movement of a motor.

Yet another objective of the present invention is to provide a system and method for delivering a haptic force feedback with a moving capstan drive mechanism to convert a linear movement of a hand tool into a rotary movement of a motor shaft.

These and the other objects and advantages of this invention will be understood easily by studying the following specification with the accompanying drawings.

### SUMMARY OF THE INVENTION

The various embodiments of the present invention provide a system and method for delivering a haptic force feedback from a motor to a human hand in a virtual reality system using a cable and moving capstan drive mechanism. The moving capstan in the present invention is allowed to rotate and move (linearly) co-axially to motor shaft. The rotational motion of the moving capstan is transferred to the motor shaft. As a result, a cable sideways movement is eliminated and thus in turn eliminates the slackening effect of the cable.

According to an embodiment, a system is provided for delivering a haptic force feedback to a user during a movement of the vocational tool handles in a roll and handle assembly. The system comprises a holder and a moving capstan drive mechanism is connected to the holder. A motor is connected to the moving capstan mechanism. A position sensor is connected to the motor. The position sensor is connected to an information processor. A control circuit connected to the information processor controls the torque delivered by the motor.

The tool handle in the roll and handle assembly is connected to the moving capstan drive mechanism to transfer the linear displacement of the tool handle in the roll and handle assembly into a rotational movement of motor and vice versa. When the tool handle is displaced linearly by the user, the position sensor outputs a signal based on the rotational movement of the motor shaft to the information processor to provide a virtual reality display and a haptic force feedback to the user in either direction accordingly and opposing the movement of the tool handle.

A cable is connected between two distal ends of the holder in the roll and handles assembly. The cable is passed and wound over the moving capstan. The moving capstan drive mechanism comprises a moving capstan and wherein the cable is passed and wound over the moving capstan. The moving capstan is coupled to sleeve by means of two pins. The sleeve is coupled to a shaft of the actuator (motor).

The moving capstan is rotated and as well as moved linearly (co-axial to motor shaft). The tool handle in the roll and handle assembly is displaced linearly to move the cable wound on the moving capstan to rotate and move linearly (co-axially to motor) in turn to rotate the sleeve to rotate the motor by means of two pins.

The system further comprises a yaw and pitch assembly connected to the base of the moving capstan mechanism which is the part of roll and handle assembly to vary, pitch, yaw and roll angle of a haptic device. The system further comprises a load cell assembly mounted below the yaw and pitch assembly to detect a load of a vertical force applied during a movement of the roll and handle assembly in the haptic device.

According to an embodiment, a method is provided for delivering a haptic force feedback to a user during an operation of a vocational hand tool. The method involves connecting a holder to a moving capstan drive mechanism. A motor is coupled to the moving capstan drive mechanism. A sensor is provided to detect a rotational movement of the motor. An information processor is communicatively connected to the sensor to receive an output of the sensor. The information processor communicates the force feedback information to the control circuit which provides a haptic feedback based on the force computation algorithm. A result of a vocational hand tool operation is provided to a user by displaying the result on a monitor using the information processor.

The holder is displaced linearly to rotate and move the moving capstan mechanism to rotate the motor and the sensor detects the rotational movement to output a signal to the control circuit to provide a haptic feedback to a user, when the user displaces the holder.

The holder is connected to the moving capstan mechanism to transfer the linear displacement of the holder into a rotational movement of motor and the sensor outputs a signal based on the rotational movement of the motor to the control circuit to provide a haptic feedback to a user and to provide a display on the information processor, when the holder is displaced linearly by the user.

A cable is connected between two distal ends of the holder. The cable is passed and wound over the moving capstan mechanism. The moving capstan mechanism comprises a moving capstan and wherein the cable is passed and wound over the moving capstan. The moving capstan is coupled to sleeve by means of two pins. The sleeve is coupled to a shaft of the motor. The system further comprises a tool connected to the moving capstan mechanism.

The moving capstan is rotated and as well as moved co-axially (linearly) to motor. The holder is displaced linearly to move the cable wound on the moving capstan to rotate and move the moving capstan linearly to rotate the shaft to rotate the motor. The sensor detects the rotation of the motor and outputs a signal based on the rotation of the motor to the control circuit to provide a haptic feed back to the user.

According to an embodiment of the present invention, a system is provided for delivering a haptic force feedback to a user during an operation of a vocational hand tool connected in the haptics device. The system comprises a base and a roll and handle assembly is mounted on the base. A moving capstan mechanism is provided in the roll and handle assembly. A yaw and pitch assembly is arranged below the base. A load cell assembly is provided below the yaw, and pitch assembly. A control circuit is communicatively connected to the sensor assembly and an information processor.

The roll and handle assembly is moved linearly to rotate and move the moving capstan drive mechanism to rotate a motor drive. The encoder assembly detects the rotation of the motor to output a signal to an information processor. The information processor is provided with software to generate a virtual reality environment to provide a haptic force feedback to a user based on the output of the control circuit, when the roll and handle assembly is operated.

The roll and handle assembly is moved and rotated for any rotational degree of freedom “Roll”. The yaw and pitch assembly is provided to vary the pitch, yaw angle of the movement of the roll and handle assembly. The load cell assembly detects the load of the force applied by human hands of a user during the movement of the roll and handle assembly along with its rotation of yaw and pitch.

The roll and handle assembly comprises two holder supports mounted on the base. A linear guide (carriage) is mounted on the base and a linear rail slides over the guide. Linear guide connects the two holder supports and rotating plates are mounted on the two holder supports respectively. A circular rod is connected between the two rotating plates. A handle is connected to one of the two rotating holders. Two cable supports are mounted on a side surface in the two holder supports respectively and a cable is connected between the two cable supports.

The moving capstan assembly comprises two vertical holder supports mounted on the base. A linear guide rail is attached to two holder supports. A sleeve is coupled to the moving capstan by means of two pins. An actuator (motor) is coupled to the sleeve through motor shaft. An encoder wheel mounted behind the sleeve in the motor shaft.

The cable is connected between the cable supports attached to the two holder supports in the roll and handle assembly and is made to pass over the moving capstan so that the moving capstan is rotated and moved co-axially to the motor (linearly) when the roll and handle assembly is operated to move linearly and in any roll angle within limit. The sleeve is also to be rotated along with it thereby rotating the shaft of the motor, when the moving capstan is rotated and wherein the rotation speed of the motor is detected and measured by the encoder wheel.

The yaw assembly comprises two vertical outer supports. Two vertical inner supports are attached to the two vertical outer supports. A ring support platform is mounted between the two vertical inner supports. A rotatable ring is mounted on the ring support platform to hold and support the base where in the roll and handle assembly along with the moving capstan drive mechanism is mounted. A vertical shaft is attached to the bottom of base and fitted in the ring support platform. A load measurement mechanism is attached to the bottom of whole assembly. The roll and handle assembly is rotatably moved over the ring platform so that the handle in the roll and handle assembly is arranged in a left handed position or in a right handed position at any angle in specific increment within the limits and can be locked by means of pins at a required position or the rotation of roll and handle assembly in the base over the ring support platform makes the yaw rotation movement.

The load cell assembly comprises an upper plate, a lower plate and a load cell mechanism. The load cell mechanism is arranged between the upper plate and the lower plate to measure the vertical load applied when a device is operated using the roll and handle assembly.

The information processor has a local controller to read the output signal from the sensor assembly to provide an actuation signal to a control circuit to drive a motor to rotate the drive and capstan assembly to provide a force feedback to the user, when the connected roll and handle assembly is operated.

According to an embodiment of the present invention, the virtual reality system consists of a host computer and a haptic device. The communication between the haptic device and the host computer is established through a USB communication channel. The host computer is running a custom haptic device driver and a virtual reality environment software application. The custom haptic device driver talks to haptic device and transfers the signals bidirectionally between the device and the virtual reality environment software application.

The haptic device consists of plurality of position sensors and a dc motor. The haptic device further consists of a 32 bit Programmable Integrated Circuit (PIC) local controller which reads the sensor information from the four rotary position sensors and provides actuation signals via the motor drive control circuit to the force actuator.

According to an embodiment of the present invention, the haptic device consists of a handle, an actuator shaft, a moving capstan, a supporting immovable frame, a sleeve, a cable and a holder. The moving capstan consists of inner thread mounted on a screw. The screw is fixed at one end to an immovable supporting frame. The supporting frame is made immovable by fixing it by means of screws over a base. The supporting immovable frame can be moved and adjusted by means of a guided key to keep the whole assembly in line with a motor shaft. The moving capstan has external threads on the outer surface. The moving capstan has two through holes which are arranged in parallel to and at equal spacing from the cylindrical axis. The inner and outer threads of a moving capstan have same pitch.

According to an embodiment of the present invention, the sleeve is fixed to an encoder and to a motor shaft by means of screws. The sleeve consists of two pins. The two pins are aligned to the moving capstan holes and are arranged in parallel to and at equal spacing from the cylindrical axis. The two pins have a sliding fit with the moving capstan holes. The two pins are rigidly attached to the sleeve by means of screws.

According to an embodiment of the present invention, the cable is wound over an outer thread of the moving capstan. The cable is fixed at both ends to the holder. The motor is fixed rigidly over a plate using screws and plate is fixed in the base.

According to an embodiment of the present invention, an encoder reader and an encoder wheel are used for a positional feedback of linear movement of haptic device.

According to an embodiment of the present invention, the mechanism of delivering a haptic force feedback from a motor to a human hand comprises the steps of moving a tool handle by a user. Since the tool handle is fastened to a holder, the holder moves along a guided linear path by means of a guide (carriage) and a rail. While the holder is moved along a linear path as the cable is fixed to the holder, the cable rotates moving capstan. As the moving capstan is free to rotate and move over a screw, the drum rotates as well as moves co-axially to motor shaft. The moving capstan can move co-axially to motor shaft along any direction (i.e. sideways) according to a forward or a reverse movement of the cable. The moving capstan rotates the two pins along with it, when the moving capstan is rotated and moved co-axially to motor shaft. Hence the rotational movement of moving capstan is transferred to the pins. The co-axial movement to the motor shaft of the moving capstan is not transferred to the pins as the drum slides over the pins and thus transfer of co-axial movement of moving capstan to sleeve is eliminated. The rotation of pins in turn rotates a sleeve in which pins are fastened. The sleeve in turn rotates the motor shaft.

Further the rotational movement of the motor shaft leads to the helical movement of the moving capstan. The moving capstan in turn moves the holder in the linear path by a guide and rail system assembly. Since the tool handle of the haptics device is fastened to the holder, the human hand holding the tool handle experiences the force-feed back.

According to an embodiment of the present invention, the haptic device consists of one active translational and three passive rotational degrees of freedom. The rotational degrees of freedom are along the yaw, pitch and roll axes.

According to an another embodiment of the present invention, the haptic device along with multiple Virtual Reality (VR) interfaces and a haptic rendering is designed to simulate multiple vocational hand tools using interchangeable handles.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a functional block diagram of a system for delivering haptic force feedback, according to an embodiment of the present invention.

FIG. 2 illustrates a functional block circuit diagram of a control circuit in a system for delivering haptic force feedback indicating a data transfer between a haptic device and an information processor, according to an embodiment of the present invention.

FIG. 3 illustrates an exploded perspective view of a system for delivering haptic force feedback, according to an embodiment of the present invention.

FIG. 4 illustrates a side view of a system for delivering haptic force feedback, according to an embodiment of the present invention.

FIG. 5 illustrates an exploded perspective view of a handle and roll assembly in a system for delivering haptic force feedback, according to an embodiment of the present invention.

FIG. 6 illustrates an exploded perspective view of a cable and moving capstan drive assembly in a system for delivering haptic force feedback, according to an embodiment of the present invention.

FIG. 7 illustrates a perspective view of a moving capstan drive mechanism in a moving capstan assembly in a system for delivering haptic force feedback, according to an embodiment of the present invention.

FIG. 8 illustrates an exploded perspective view of a yaw assembly in a system for delivering haptic force feedback, according to an embodiment of the present invention.

FIG. 9 illustrates an exploded perspective view of a load cell assembly in a system for delivering haptic force feedback, according to an embodiment of the present invention.

FIG. 10 illustrates a side view of a system for delivering haptic force feedback, according to an embodiment of the present invention, with pitch rotation (tool handle in a down position).

FIG. 11 illustrates a side view of a system for delivering haptic force feedback, according to an embodiment of the present invention, with pitch rotation (tool handle in an upward position).

FIG. 12 illustrates a top side view of a system for delivering haptic force feedback, according to an embodiment of the present invention, with roll rotation (tool handle in a horizontal position).

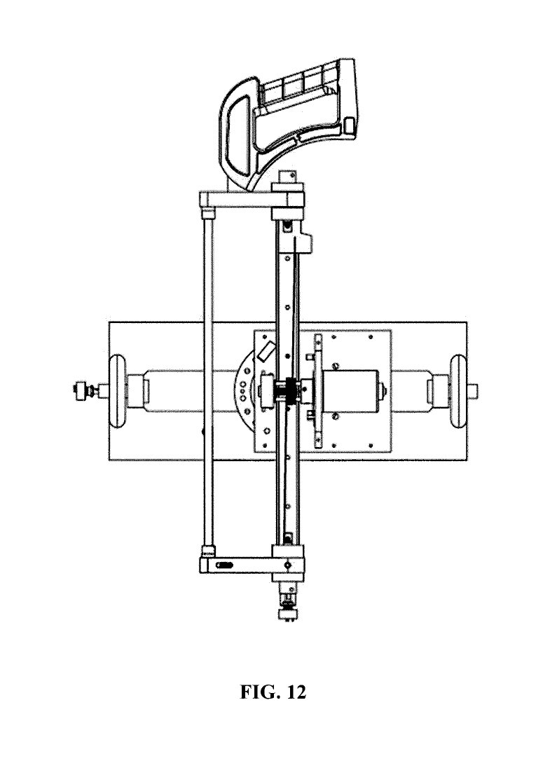

FIG. 13 illustrates a side perspective view of a system for delivering haptic force feedback, according to an embodiment of the present invention, with roll rotation (tool handle in a left hand position).

FIG. 14 illustrates a side view of a system for delivering haptic force feedback, according to an embodiment of the present invention, with roll rotation (tool handle in left hand position).

FIG. 15 illustrates a side view of a system for delivering haptic force feedback, according to an embodiment of the present invention, with roll rotation (tool handle in right hand position).

FIG. 16 illustrates a top side view of a system for delivering haptic force feedback, according to an embodiment of the present invention, with yaw rotation.

FIG. 17 illustrates a top side view of a system for delivering haptic force feedback, according to an embodiment of the present invention, with yaw rotation.

FIG. 18 illustrates a side view of a system for delivering haptic force feedback indicating a movement of a moving capstan and a sleeve, according to an embodiment of the present invention.

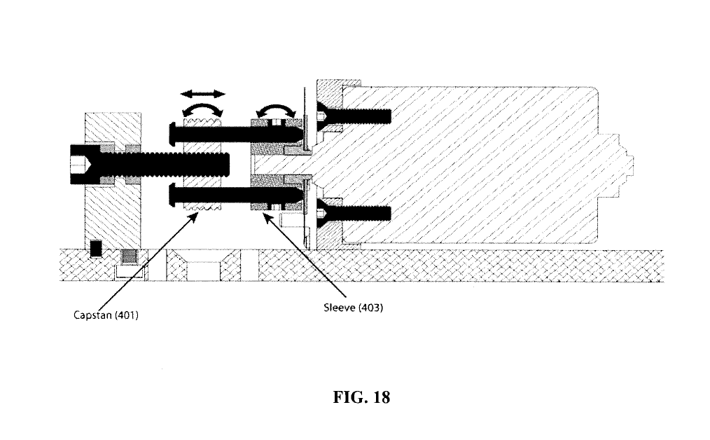

FIG. 19 illustrates a top side view of a system for delivering haptic force feedback indicating a yaw rotation and a pitch rotation according to an embodiment of the present invention.

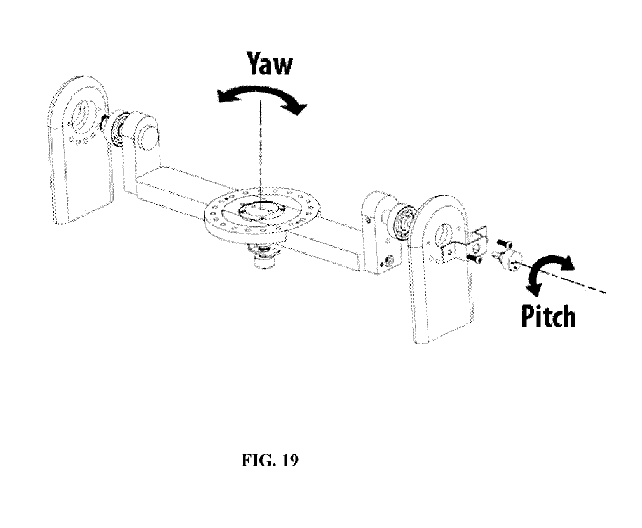

FIG. 20 illustrates a isometric view of a system for delivering haptic force feedback indicating a detachable tool handle in roll and handle assembly according to an embodiment of the present invention.

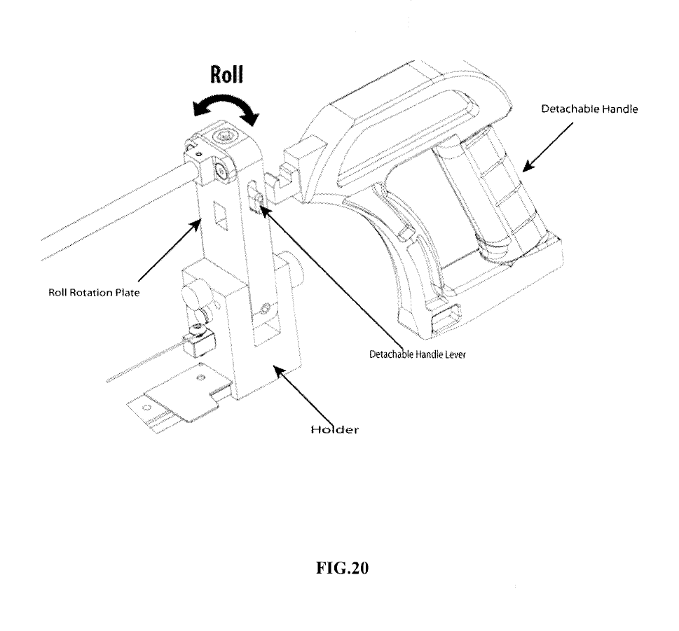

FIG. 21 illustrates a isometric view of a system for delivering haptic force feedback indicating a detachable tool handle in roll and handle assembly according to an embodiment of the present invention.

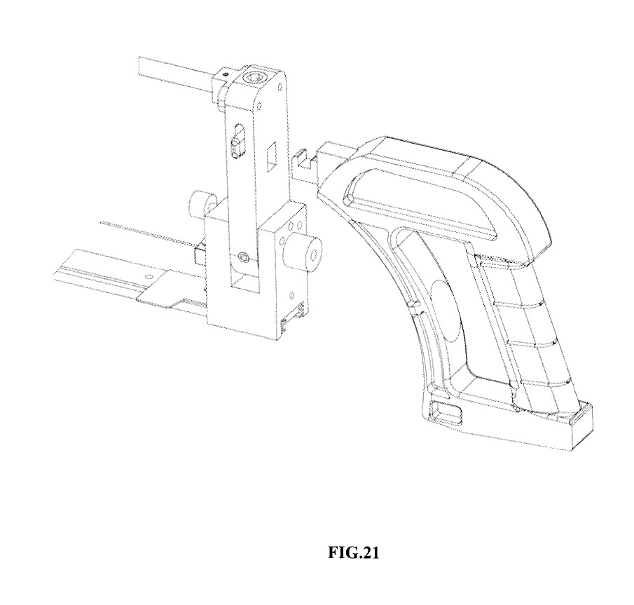

Although the specific features of the present invention are shown in some drawings and not in others. This is done for convenience only as each feature may be combined with any or all of the other features in accordance with the present invention.

### DETAILED DESCRIPTION OF THE INVENTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments of the present invention provide a system and mechanism for delivering a haptic force feedback from an actuator (motor) to a human hand in a virtual reality system. The moving capstan in the present invention is allowed to rotate and move co-axially to the motor in any direction (i.e. sideways). Since the capstan is moving and coupled (linked) to sleeve by means of two pins only the rotational motion of the moving capstan is transferred to the motor shaft. The cable is not moving sideways due to moving capstan, thus the slackening effect of the cable is eliminated.

According to an embodiment, a system is provided for delivering a haptic force feedback to a user during an operation of a hand tool. The system comprises a holder and a moving capstan drive mechanism is connected to the holder. A motor is connected to the moving capstan drive mechanism. A sensor is connected to the motor. A control circuit is connected to the sensor and an information processor is connected to the control circuit.

The Holder is connected to the moving capstan drive mechanism to transfer a linear displacement of the holder into a rotational movement of motor. The sensor outputs a signal based on the rotational movement of the motor to the control circuit to provide a haptic feedback to a user and to provide a display on the information processor, when the holder is displaced linearly by the user. The information processor is loaded with virtual reality environment software to provide a force feedback to the user, when the holder is displaced.

A cable is connected between the two distal ends of the movable frame holder. The cable is passed and wound over the moving capstan drive mechanism. The moving capstan is coupled/linked to sleeve by means of two pins. The sleeve is fastened to a shaft of the motor. The system further comprises a hand tool (tool handle) connected to the holder.

The moving capstan is rotated and as well moved linearly (co-axially to motor shaft). The holder is displaced linearly to move the cable wound on the moving capstan to rotate and move the moving capstan linearly (co-axially to motor shaft) to rotate the sleeve by means of two pins and in turn to rotate the motor. The sensor detects the rotation of the motor and outputs a signal based on the rotation of the motor to the control circuit to provide a haptic feed back to the user.

The system further comprises a yaw and pitch assemblies connected to the base of the roll and handle assembly which has moving capstan drive mechanism to vary pitch, yaw and angle of a hand tool within the specified limits. The system further comprises a load cell assembly mounted below the yaw and pitch assemblies to detect a force applied during a movement of the hand tool. The tool handle can be rotated for roll angle by rotating the roll rotation plate pivoted in holder. Tool handle is fastened to roll rotation plate.

According to an embodiment, a method is provided for delivering a haptic force feedback to a user during an operation of a hand tool. The method involves connecting a holder to a moving capstan drive mechanism. A motor is coupled to the moving capstan drive mechanism. A sensor is provided to detect a rotational movement of the motor. An information processor is communicatively connected to the sensor to receive an output of the sensor. The control circuit provides a haptic feedback based on the received output of the sensor from the information processor. A result of a hand tool operation is provided to a user by displaying the result on a monitor using the information processor.

The holder is displaced linearly to rotate and move the moving capstan mechanism to rotate the motor and the sensor detects the rotational movement to output a signal to the control circuit to provide a haptic feedback to a user, when the user displaces the holder.

The holder is connected to the moving capstan mechanism to transfer a linear displacement of the holder into a rotational movement of motor. The sensor outputs a signal based on the rotational movement of the motor to the control circuit to provide a haptic feedback to a user and to provide a display on the information processor, when the holder is displaced linearly by the user.

A cable is connected between the two distal ends of the holder. The cable is passed and wound over the moving capstan mechanism. The moving capstan mechanism comprises a moving capstan and the cable is passed and wound over the moving capstan. The moving capstan is connected to sleeve. The sleeve is coupled to a shaft of the motor. The system further comprises a hand tool connected to the moving capstan mechanism.

The moving capstan is rotated and as well moved co-axially (linearly) to the motor. The holder is displaced linearly to move the cable wound on the moving capstan to rotate and move the moving capstan co-axially to the motor to rotate the motor shaft to rotate the motor. The sensor detects the rotation of the motor and outputs a signal based on the rotation of the motor to the control circuit to provide a haptic feed back to the user.

According to an embodiment of the present invention, the virtual reality system consists of a host computer and a haptic device. The communication between the haptic device and the host computer is established through a USB communication channel. The host computer is running a custom haptic device driver and a virtual reality environment software application. The custom haptic device driver talks to haptic device and transfers the signals bi-directionally between the device and the virtual reality environment software application.

The haptic device consists of a plurality of position sensors and actuators and a Direct Current (DC) motor. The haptic device further consists of a 32 bit Programmable Integrated Circuit (PIC) local controller which reads the sensor information from the four rotary position sensors and provides actuation signals via the motor drive control circuit to the force actuator.

According an embodiment of the present invention, a system for providing a haptic force feedback comprises a base, a roll and handle assembly, a moving capstan drive mechanism, a yaw and pitch assembly, a load cell assembly, a motor drive, a sensor assembly, a control circuit and an Information processor.

A roll and handle assembly is mounted on a base. The moving capstan drive mechanism is arranged in the roll handle assembly which is mounted on a base. A yaw and pitch assembly is connected to the roll and handle assembly through a shaft mounted below the base in the roll and handle assembly. A load cell assembly is arranged below the yaw and pitch assembly. The exterior support frame holding the yaw and pitch assembly is mounted over the load cell assembly.

A motor drive is connected to moving capstan drive mechanism. A sensor assembly is provided to detect the rotation of the motor drive. A control circuit is communicatively connected to the sensor assembly. An information processor is communicatively connected to the control circuit.

The roll and handle assembly is moved linearly to rotate and move the moving capstan mechanism to rotate a motor drive. The sensor detects the rotation of the motor to output a signal to a control circuit to provide a haptic feed back through the information processor. The information processor is provided with software to generate a virtual environment to provide a haptic force feedback to a user based on the output of the control circuit, when the roll and handle assembly is operated.

The roll and handle assembly is moved in any angle in upwards, sideways and downwards. The yaw and pitch assembly is provided to vary the pitch, yaw angle of the movement of the roll and handle assembly. The load cell assembly detects the load of the force applied during the movement of the roll and handle assembly.

According to an embodiment of the present invention, the roll and handle assembly comprises a rail and carriage (guide), two roll rotation plates, two holders, a circular rod, a tool handle, a cable support and a cable. The roll and handle assembly is mounted on a base. The roll and handle assembly has a linear guide (carriage—igus product) mounted on the base. The rail (igus product) is connected are mounted at the two distal ends of two holders. Each of the two holder supports has a first groove at the bottom side and a second groove on the top side. The first groove/slot is provided at the bottom portion in each of the two holder supports to receive the rail (igus product). The second groove/slot is provided at the top portion in each of the two holder supports to receive and hold the two roll rotation plates respectively. The two roll rotation plates are pivotally connected to the two holder so that the two roll rotation plates are pivotally rotated on an axis. A circular rod is connected between the two roll rotation plates to make it a single assembly. A tool handle is attached to a side in one or the two roll rotation plates (depends upon which type of tool handle is used) so that the tool handle is pivotally rotated on an axis which is called as rotational degree of freedom “Roll”. The tool handle can be moved and locked at given holes in both the holders at specific angle by means of locking pins or can be moved continuously with in the specified angle limit. The roll rotation is measured by means of potentiometer connected to one of the roll rotation plate. The potentiometer assembly includes a potentiometer attached to the roll rotation plate using an angled frame. The angled frame has a strip bent twice at right angles to form an S-shaped frame. Both the distal ends of the angled frame are bent at right angles in opposite directions. One end of the angled frame is connected to the roll rotation plate through a fastener while the other end of the angled frame is attached to the potentiometer shaft to measure roll rotation. A cable support is provided at a side surface in both the two holders to hold a cable between the two holder supports. The cable supports provided on both the two holder supports are arranged opposite to each other to get a shift between opposite cable ends as shown in figure. A cable is held between the two holders by fixing the two ends of the cable to the cable supports provided in the two holder supports respectively.

According to an embodiment of the present invention, a moving capstan mechanism comprises two vertical supports, a linear rail and guide (carriage), a moving capstan, a sleeve, a motor and an encoder wheel. The moving capstan drive mechanism has one immovable frame mounted on a base to hold a moving capstan. The moving capstan is coupled to a sleeve mounted over a shaft by means of two sliding pins of an actuator (motor) which is mounted on the base. An encoder wheel is attached behind the sleeve and mounted over the shaft of the motor. The cable provided in the roll and handle assembly is made to pass over the moving capstan.

The moving capstan is coupled to the sleeve through two pins. The moving capstan is provided with two holes through which the two pins are passed through. The sleeve is provided with the two holes at same pitch circle diameter of moving capstan holes and aligned to those holes. The two pins are fastened to sleeve by means of screws. The sleeve is mounted over the shaft motor through the fasteners. The fasteners are passed through the holes provided at the peripheral cylindrical surface of the sleeve to mount the sleeve over the shaft of the motor. The encoder wheel is arranged after the sleeve and mounted over the shaft of the motor. The motor fixing plate has a central hole to receive the shaft of the motor. The motor is mounted on the base through motor fixing plate.

The cable connected between the cable supports attached to the two holder supports in the roll and handle assembly is made to pass over the moving capstan so that the moving capstan is rotated and moved linearly when the roll and handle assembly is operated to move in any direction at any angle. When the moving capstan is rotated, the sleeve is also rotated along with it thereby rotating the shaft of the motor. The rotation speed of the motor is detected and measured by the encoder wheel.

According to an embodiment of the present invention, a yaw and pitch assembly comprises two vertical outer supports, two vertical inner supports, a ring support platform, a ring, and a vertical shaft. The yaw and pitch assembly has a ring support platform mounted with a ring. The support platform has a groove to receive and hold the rotatable ring. The ring is fastened to support platform by means of screws. The base support the roll and handle assembly along with the moving capstan drive mechanism. A vertical shaft is attached to the base. The vertical shaft is received in a central hole provided in the of the ring support platform and is fastened to the ring support platform through a bush and a bearing arrangement. The ring support platform is fixed between two vertical inner supports. The two distal ends of the ring support platform are fixed to the two vertical inner support platforms through fasteners. The fasteners include a screw. The two vertical inner supports are connected to two vertical outer supports through two set of pins and bearings. The length of the two vertical outer supports is more than the length of the two vertical inner supports so that the ring support platform is hung from the two outer vertical supports. Two potentiometers are attached to the yaw and pitch assembly. One potentiometer is attached to the bottom of the ring support platform for sensing the yaw rotation and another potentiometer is attached to one of the vertical outer support from outside. The potentiometer assembly includes a potentiometer attached to the ring support platform and any one of the vertical outer support using two angled frames. The angled frame has a strip bent twice at right angles to form an S-shaped frame. Both the distal ends of the angled frame are bent at right angles in opposite directions. One end of the angled frame is connected to the bottom of the ring support platform through a fastener while the other end of the angled frame is attached to the potentiometer shaft to measure yaw rotation. In the same way, one end of angle frame is attached to a vertical outer support and another end is attached to the potentiometer shaft to measure a pitch rotation. The potentiometer is used for measuring the yaw rotation and pitch rotation.

The yaw and pitch assembly is provided to vary the pitch and yaw of the roll and handle assembly. The roll and handle assembly is rotatably moved over the ring platform so that the handle in the roll and handle assembly is arranged in a left handed position or in a right handed position both in yaw and pitch rotational movements and can be locked at that position at the given holes in the ring for yaw movement and at the given holes in the vertical outer support by means of the locking pins or can be moved continuously also both in yaw and pitch rotational movement with in specified angle limits.

According to an embodiment of the present invention, a load cell assembly comprises an upper plate, a lower plate and a load cell mechanism. The load assembly has a load cell mechanism arranged between the two rectangular plates. The two rectangular plates include an upper plate and a lower plate. One end of the load cell mechanism is connected to the upper plate through a fastener while the other end of the lead cell mechanism is connected to the bottom plate through another fastener. The fastener includes a washer and a nut and bolt arrangement. The upper plate and the lower plate are attached to each through a securing means. The securing means include a nut and bolt arrangement, threaded screws, guide pins, etc.

The load cell assembly is arranged below the yaw and pitch assembly to measure the load applied using the roll and handle assembly. The two outer vertical supports of the yaw and pitch assembly are mounted and attached to the upper plate in the load cell assembly. Upper plate will move down while a load is applied by means of tool handle and holders in the roll and handle assembly. The upper plate is guided by two pins and free movement on vertical direction either upward or downward. When the load is applied, upper plate moves down and the shear experienced by the load cell produces a proportional analog voltage signal which is amplified using an amplifier circuit and transmitted to the information processor.

According to an embodiment of the present invention, the haptic device consists of a tool handle, an actuator shaft, a moving capstan, a supporting immovable frame, a sleeve, a cable and a holder. The moving capstan consists of inner threads mounted on a screw. The screw is fixed at one end to an immovable supporting frame. The supporting frame is made immovable by fixing it by means of screws over a base. The supporting frame can be moved and adjusted by means of a guided key to keep the whole assembly in line with a motor shaft. The moving capstan has external threads on the outer surface. The moving capstan has two through holes arranged in parallel to and at equal spacing from the cylindrical axis. The inner and outer threads of the moving capstan have same pitch.

According to an embodiment of the present invention, the sleeve is fixed to encoder and motor shaft by means of screws. The sleeve consists of two pins. The two pins are aligned to the floating drum holes and are in parallel to and at equal spacing from the cylindrical axis. The two pins have a sliding fit with the moving capstan holes. The two pins are rigidly attached to the sleeve by means of screws.

According to an embodiment of the present invention, the cable is wound over the outer thread of moving capstan. The cable is fixed at both ends to the holder. The motor is fixed rigidly over a motor fixing plate using screws.

According to an embodiment of the present invention, an encoder reader and an encoder wheel are used for linear position measurement of the roll and handle assembly and three potentiometers are used to measure the yaw, pitch and roll.

According to an embodiment of the present invention, the mechanism of delivering a haptic force feedback from a motor to a human hand comprises the steps of moving a tool handle by a user. Since the tool handle is fastened to a holder, the holder moves along the guided linear path by means of guide (carriage) and rail. While the holder is moved in a linear path as the cable is fixed to the holder, it rotates the moving capstan. As the floating moving capstan is free to rotate/move co-axially to motor shaft over a screw, it rotates and also moves axially. The moving capstan can move co-axially to motor shaft in any direction according to the forward and reverse movement of the roll and handle assembly. The moving capstan rotates the two pins along with it, when it rotates and moves co-axially. Hence the rotational movement of the moving capstan is transferred to the pins. The axial movement of the moving capstan is not transferred to the pins as the moving capstan slides over the pins. The rotation of the pins in turn rotates a sleeve fastened to the pins. The sleeve in turn rotates the motor shaft.

Further the rotational movement of the motor shaft leads to the helical movement of the moving capstan. The moving capstan in turn moves the holder in the linear path by the guide (carriage) and rail system assembly. Since the holder is fastened to the handle of the haptic device, the human hand holding the holder experiences the force feedback.

According to an embodiment of the present invention, the haptic device consists of one active translational and three passive rotational degrees of freedom. The rotational degrees of freedom are along the yaw, pitch and roll axes.

According to an another embodiment of the present invention, the haptic device is provided with multiple Virtual Reality (VR) interfaces and a haptic rendering is designed to simulate the multiple vocational tools using the interchangeable handles.

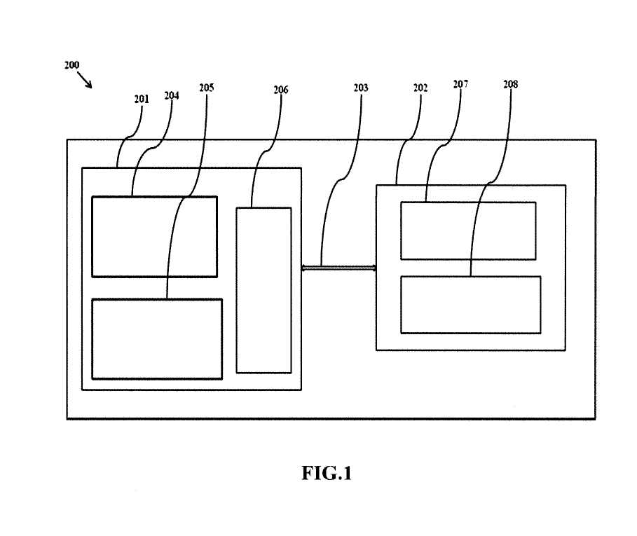

FIG. 1 illustrates a functional block diagram of a system for delivering haptic force feedback, according to an embodiment of the present invention. With respect to FIG. 1, the system 200 consists of a haptic device 201 and a host computer 202. The communication between the haptic device and the host computer is established through a USB communication channel 203.

The haptic device 201 comprises a motor drive 204, which is rotated based on the movement of a movable capstan mechanism due to an operation of a hand tool. A plurality of sensors and actuators 205 detects the rotation of the motor drive 204. A control card 206 outputs a signal to a host computer 202 through a USB communication bus 203 based on the detection output received from the sensors 205. The host computer 202 in the haptic device further consists of driver software 207 for the actuators or the motors. The driver software 207 is operated to provide communication between the haptic device and the host computer consisting of a virtual environment to provide a haptic feedback to a user when a hand tool is operated. The sensors 205 are provided to sense the mechanical action from the user. The motors 204 are operated to return the force feedback to the user. The control card 206 is to regulate the torque of the motor or the force of the actuator and to read the sensor values.

The host computer 202 is running a haptic device driver software 207 and virtual reality environment software 208. The virtual reality environment software allows the programming of the haptic device. The virtual reality environment software is built using graphics libraries like OpenGL, DirectX and 3D engines like Unity3D, Unreal SDK and Ogre 3D and haptic rendering is achieved using haptic libraries such as CHAI 3D, Open haptics SDK and H3D. The haptic device driver communicates with the haptic device and provides bidirectional signal transfer between the haptic device and the host computer running the Virtual Reality environment software.

The haptic device 201 consists of one active translational and three passive rotational degrees of freedom. The rotational degrees of freedom are along the yaw, pitch and roll axes. The haptic device 201 along with multiple VR interfaces and haptic rendering is designed to simulate the multiple vocational tools, using the interchangeable handles.

The haptic device 201 consists of a 32 bit PIC local controller 206 which reads the sensor information from the four rotary position sensors 205 and provides actuation signals via the motor drive control circuit 204 to the force actuator (DC motor) 204. The communication between the Haptic device 201 and the Host computer 202 is established through a Serial to USB communication channel 203.

At the PC 202 end, the custom haptic device driver 208 communicates with the haptic device 201 to transfer the signals bi-directionally between the haptic device 201 and the Virtual Reality environment software application (208).

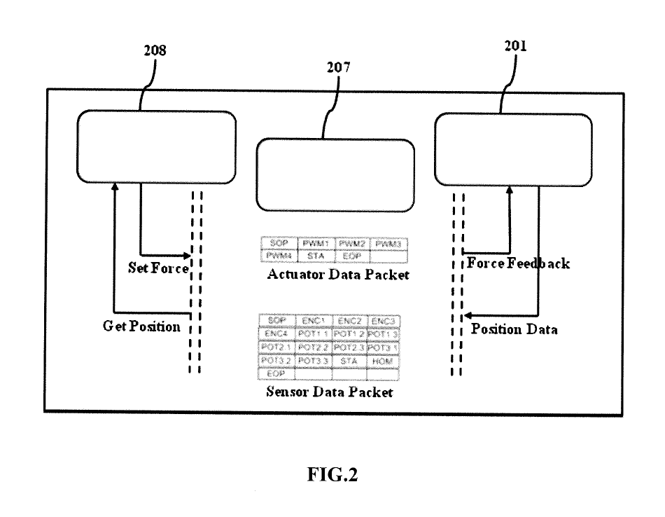

FIG. 2 illustrates a functional block circuit diagram of a communication interface in a system for delivering haptic force feedback indicating a data transfer between a haptic device and an information processor, according to an embodiment of the present invention. With respect to FIG. 2, the sensors in the haptic device detect the mechanical force exerted by the human hand. The position data from the sensors is sent to the haptic device driver 207. The haptic device driver processes the position data and gets the position of the point of force applied and sends it to the virtual reality environment software 208. The virtual reality environment software 208 calculates the amount of feedback force needed and sends it to the haptic device driver 207. The haptic device driver 207 in turn sends the data packets to the haptic device. The haptic device computes the specified amount of feedback force and transfers it to the human hand through an actuator.

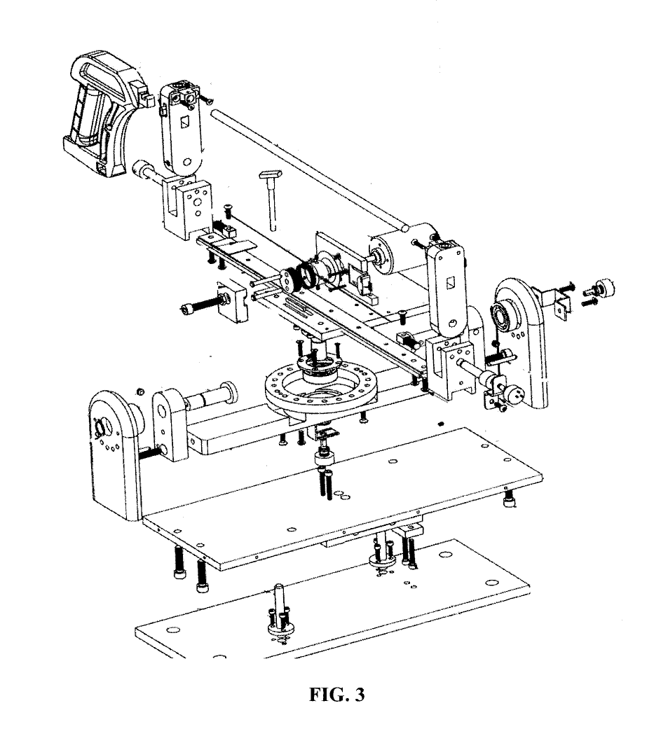

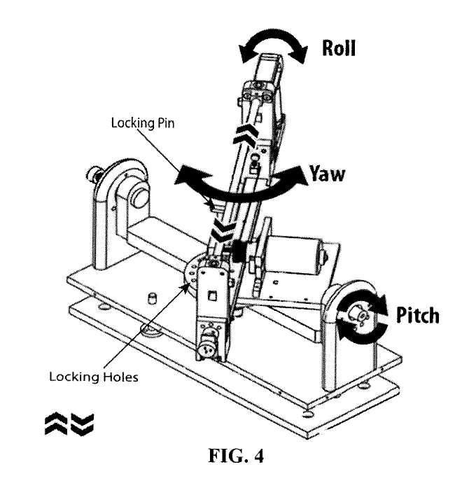

FIG. 3 illustrates an exploded perspective view of a system for delivering haptic force feedback, according to an embodiment of the present invention, while FIG. 4 illustrates a side view of a system for delivering haptic force feedback, according to an embodiment of the present invention. With respect to FIG. 3 and FIG. 4, a system for providing a haptic force feedback comprises a base, a roll and handle assembly, a moving capstan drive mechanism, a yaw and pitch assembly, a load cell assembly, a motor drive, sensor assemblies, a control circuit and an Information processor.

A roll and handle assembly is mounted on a base. The moving capstan drive mechanism is arranged in the roll and handle assembly which is mounted on a base. A yaw and pitch assembly is connected to the roll and handle assembly through a shaft mounted below the base in the roll and handle assembly. A load cell assembly is arranged below the yaw and pitch assembly. The exterior support frame holding the yaw assembly is mounted over the load cell assembly.

A motor drive is connected to the moving capstan drive mechanism. A sensor assembly is provided to detect the rotation of the motor drive. A control circuit is communicatively connected to the sensor assembly. An information processor is communicatively connected to the control circuit.

The roll and handle assembly is moved linearly to rotate and move the moving capstan mechanism to rotate a motor drive. The sensor detects the rotation of the motor to output a signal to a control circuit to provide a haptic feed back through the information processor. The information processor is provided with software to generate a virtual environment to provide a haptic force feedback to a user based on the output of the control circuit, when the roll and handle assembly is operated.

The roll and handle assembly is moved in any angle in upwards, sideways and downwards. The yaw and pitch is assembly is provided to vary the yaw and pitch angle of the movement of the roll and handle assembly either continuously with in specified limits or to a specific angle and can be locked at the given holes in movable ring for yaw rotation and at the given holes in outer vertical support for pitch rotation at specific angle by means of locking pins. The load cell assembly detects the load of the force applied during the movement of the roll and handle assembly.

According to an embodiment of the present invention, the roll and handle assembly comprises a linear guide (carriage) and rail, two holders, two roll rotation plates, a circular rod, a handle, a cable support and a cable. The roll and handle assembly is mounted on a base. The roll and handle assembly has a linear guide mounted on the base. Two holder supports are mounted at the two distal ends of the linear guide for holding two roll rotation plates. Each of the two holders has a first groove at the bottom side and a second groove on the top side. The first groove/slot is provided at the bottom portion in each of the two holders to receive the linear guide. The second groove/slot is provided at the top portion in each of the two holder supports to receive and hold the two roll rotation plates respectively. The two roll rotation plates are holders are pivotally connected to the two holder supports so that the two roll rotation plates are pivotally rotated on axis. A circular rod is connected between the two eccentric holders. A handle is attached to a side in one or the two eccentric holders so that the handle is pivotally rotated on an axis which is called as rotational degree of freedom “Roll”. The tool handle can be moved and locked at the given holes in both the holders at specific angle by means of the locking pins or can be moved continuously with in the specified angle limit. The roll rotation is measured by means of a potentiometer connected to one of the roll rotation plate. The potentiometer assembly includes a potentiometer attached to the roll rotation plate using an angled frame. The angled frame has a strip bent twice at right angles to form an S-shaped frame. Both the distal ends of the angled frame are bent at right angles in opposite directions. One end of the angled frame is connected to the roll rotation plate through a fastener while the other end of the angled frame is attached to the potentiometer shaft to measure roll rotation. A cable support is provided at a side surface in both the two holder supports to hold a cable between the two holder supports. The cable supports provided on both the two holders are arranged opposite to each other. A cable is held between the two holder supports by fixing the two ends of the cable to the cable supports provided in the two holders respectively.

According to an embodiment of the present invention, a moving capstan mechanism comprises two vertical supports, a linear guide (carriage) and rail, a moving capstan, moving capstan, sleeve, a motor and an encoder wheel. The moving capstan mechanism has mounted on a base to hold a moving capstan. The moving capstan consists of inner thread mounted on a screw. The screw is fixed at one end to an immovable supporting frame. The supporting frame is made immovable by fixing it by means of screws over a base. The supporting immovable frame can be moved and adjusted by means of a guided key to keep the whole assembly in line with a motor shaft. The moving capstan has external threads on the outer surface. The moving capstan has two through holes which are arranged in parallel to and at equal spacing from the cylindrical axis. The inner and outer threads of a moving capstan have same pitch. An encoder wheel is attached behind the sleeve and mounted over the shaft of the motor. The cable provided in the roll and handle assembly is made to pass over the moving capstan.

The first immovable frame has a central hole to receive and hold a screw. The moving capstan is coupled to the immovable frame through the screw. The moving capstan is coupled to the sleeve through two guide pins. The moving capstan is provided with two holes through which the two guide pins are passed through. The sleeve is provided with the two holes at same pitch circle diameter of capstan holes at the front flat surface to receive the two guide pins passed through the moving capstan. The sleeve is mounted over the shaft of a motor through the fasteners. The fasteners are passed through the holes provided at the outer peripheral surface of the sleeve to mount the sleeve over the shaft of the motor. The encoder wheel is arranged after the sleeve and mounted over the shaft of the motor. The encoder wheel is held with the motor fixing plate. The motor fixing plate has a central hole to receive the shaft of the motor. The motor is mounted on the base.

The cable or cable connected between the cable supports attached to the two holder supports in the roll and handle assembly is made to pass over the moving capstan so that the moving capstan is rotated and moved linearly when the roll and handle assembly is operated to move in any direction at any angle. When the moving capstan is rotated, the sleeve is also rotated along with it thereby rotating the shaft of the motor. The rotation speed of the motor is detected and measured by the encoder wheel.

According to an embodiment of the present invention, a yaw and pitch assembly comprises two vertical outer supports, two vertical inner supports, a ring support platform, a ring, and a vertical shaft. The yaw and pitch assembly has a ring support platform mounted with a ring. The support platform has a groove to receive and hold the rotatable ring. The ring is fastened to support platform by means of screws. The base support the roll and handle assembly along with the moving capstan drive mechanism. A vertical shaft is attached to the base. The vertical shaft is received in a central hole provided in the of the ring support platform and is fastened to the ring support platform through a bush and a bearing arrangement. The ring support platform is fixed between two vertical inner supports. The two distal ends of the ring support platform are fixed to the two vertical inner support platforms through fasteners. The fasteners include a screw. The two vertical inner supports are connected to two vertical outer supports through two set of pins and bearings. The length of the two vertical outer supports is more than the length of the two vertical inner supports so that the ring support platform is hung from the two outer vertical supports. Two potentiometers are attached to the yaw and pitch assembly. One potentiometer is attached to the bottom of the ring support platform for sensing the yaw rotation and another potentiometer is attached to one of the vertical outer support from outside. The potentiometer assembly includes a potentiometer attached to the ring support platform and any one of the vertical outer support using two angled frames. The angled frame has a strip bent twice at right angles to form an S-shaped frame. Both the distal ends of the angled frame are bent at right angles in opposite directions. One end of the angled frame is connected to the bottom of the ring support platform through a fastener while the other end of the angled frame is attached to the potentiometer shaft to measure yaw rotation. In the same way, one end of angle frame is attached to vertical outer support and another end is attached to the potentiometer shaft to measure pitch rotation. The potentiometer is used for measuring the yaw rotation and pitch rotation.

The yaw is assembly is provided to vary the pitch and yaw angle of the movements of the roll and handle assembly. The roll and handle assembly is rotatably moved over the ring platform so that the handle in the roll and handle assembly is arranged in a left handed position or in a right handed position. The yaw and pitch is assembly is provided to vary the yaw and pitch angle of the movement of the roll and handle assembly either continuously with in specified limits or to a specific angle and can be locked at the given holes in the movable ring for yaw rotation and at the given holes in the outer vertical support for a pitch rotation at a specific angle by means of the locking pins.

According to an embodiment of the present invention, a load cell assembly comprises an upper plate, a lower plate and a load cell mechanism. The load assembly has a load cell mechanism arranged between two rectangular plates. The two rectangular plates include an upper plate and a lower plate. One end of the load cell mechanism is connected to the upper plate through a fastener while the other end of the load cell mechanism is connected to the bottom plate through another fastener. The fastener includes a washer and a nut and bolt arrangement. The upper plate and the lower plate are attached to each through a securing means. The securing means include a nut and bolt arrangement, threaded screws, guide pins, etc.

The load cell assembly is arranged below the yaw assembly to measure the load or torque applied using the roll and handle assembly. The two outer vertical supports of the yaw assembly are mounted and attached to the upper plate in the load cell assembly.

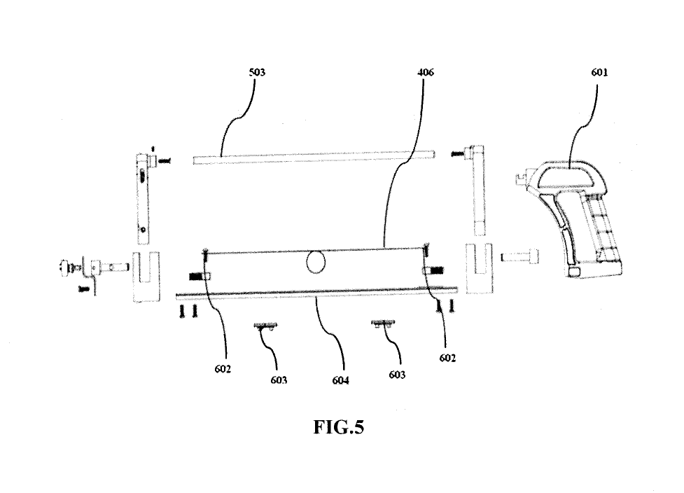

FIG. 5 illustrates an exploded perspective view of a handle and roll assembly in a system for delivering haptic force feedback, according to an embodiment of the present invention. With respect to FIG. 5, the roll and handle assembly comprises a linear rail 604, two holders, two roll rotation plates, a circular rod 503, a handle 601, a cable support and a cable. The roll and handle assembly is mounted on a base. The roll and handle assembly has a linear rail 604 mounted on the base. Two holders are mounted at the two distal ends of the linear rail 604 for holding two roll rotation plates. Each of the two holders has a first groove at the bottom side and a second groove on the top side. The first groove/slot is provided at the bottom portion in each of the two holder supports to receive the linear rail 604. The second groove/slot is provided at the top portion in each of the two holder to receive and hold the two roll rotation plates respectively. The two roll rotation plates are holders are pivotally connected to the two holder supports so that the two roll rotation plates are pivotally rotated on axis. A circular rod 503 is connected between the two roll rotation plates. A handle 601 is attached to a side in one or the two roll rotation plates so that the handle is pivotally rotated on an axis. A cable support is provided at a side surface in both the two holders to hold a cable between the two holders. The cable supports provided on both the two holder are arranged opposite to each other. A cable is held between the two holders by fixing the two ends of the cable to the cable supports provided in the two holders respectively.

With respect to FIG. 5, a tool handle 601 is fastened to the holder. The cable is fixed to the holder with the help of pair of screws 602. The holder is having a guide (carriage) 603 and a rail 604 system to move in a linear path. The user moves the tool handle 601 by exerting a mechanical force on the tool handle 601. Since the tool handle 601 is fastened to the holder, the holder moves along the guided linear path by means of guide (carriage) 603 and rail 604. The holder transfers the force to the moving cable drive mechanism. Based upon the amount of force exerted by the user, against the force converted from motor torque generated based on the interaction with the virtual environment, either the roll and handle assembly movers forward or stalls or moves backwards. In any condition force feed back is sensed at the human hand. Since the holder is fastened to the handle 601 of the haptic device, the human hand holding the holder experiences the feedback force.

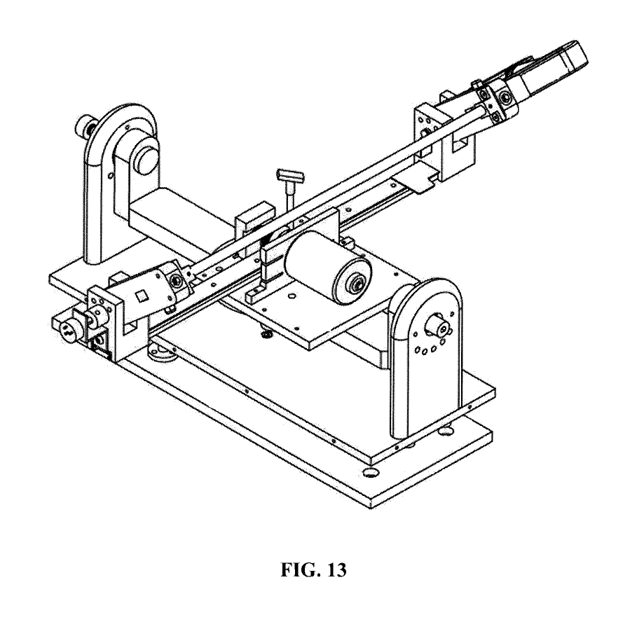

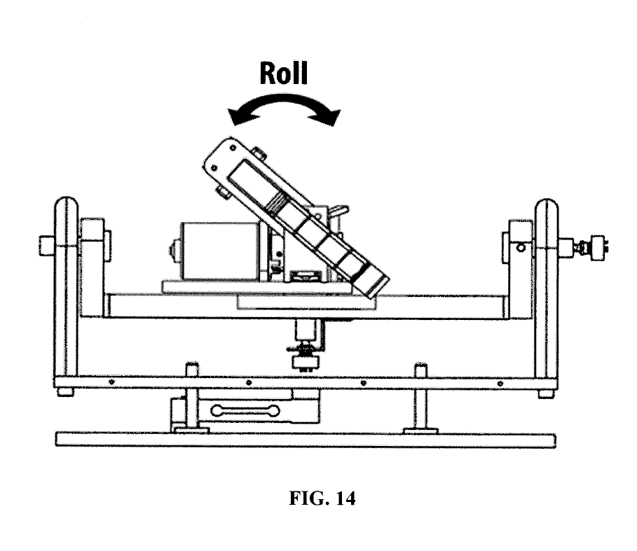

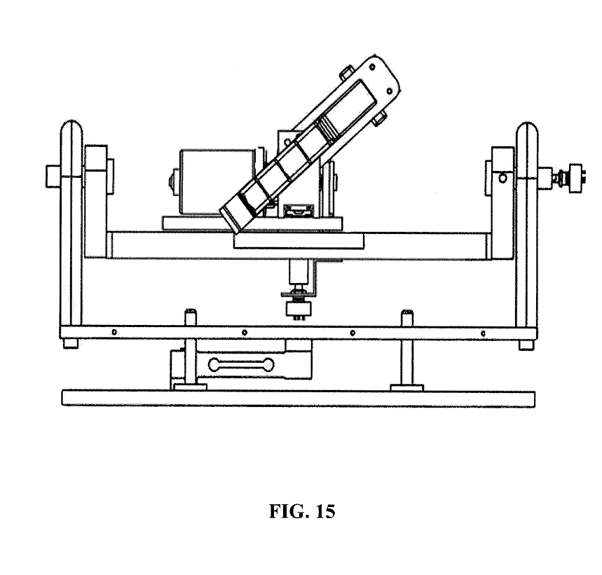

The roll and handle assemble is moved in any angle in upwards, sideways and downwards. The roll rotation handle in the roll and handle assemble is moved to a roll position as shown in FIG. 13 or to a left handed position as shown in FIG. 14 or a right handed position as shown in FIG. 15. it can be moved to a specific position and can be locked at given position by means two locking pins. The assembly can also be moved continuously within specified limit of roll angle to get a roll rotation. (rotational degree of freedom)

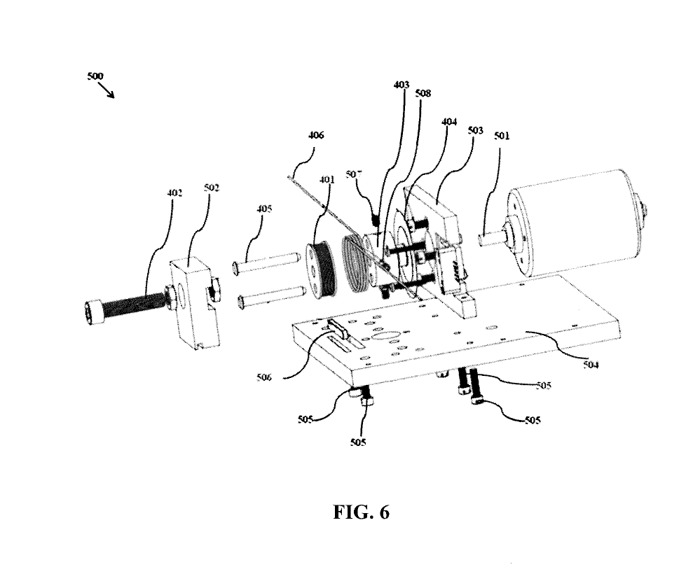

FIG. 6 illustrates an exploded perspective view of a moving capstan drive assembly in a system for delivering a haptic force feedback, according to an embodiment of the present invention. With respect to FIG. 6 a moving capstan drive mechanism comprises immovable frame 502, motor fixing plate 503, a moving capstan 401, sleeve 403, a motor and an encoder wheel 404. The moving capstan drive mechanism has immovable frame 502, mounted on a base 504 to hold a moving capstan 401. The moving capstan 401 is coupled by means of two pins 505 to a sleeve 403 mounted over a shaft 501 of a motor which is mounted on the base 504. An encoder wheel 404 is attached behind the sleeve 403 and mounted over the shaft 501 of the motor. The cable 406 provided in the roll and handle assembly is made to pass over the moving capstan 401.

The immovable frame 502 has a central hole to receive and hold a screw 402. The moving capstan 401 is coupled to the immovable frame 502 through the screw 402. The moving capstan 401 is coupled to the sleeve 403 through two guide pins 405. The moving capstan 401 is provided with two holes through which the two guide pins 405 are passed through. The sleeve 403 is provided with the two holes at the front flat surface to receive the two guide pins 405 passed through the moving capstan 401. The sleeve 403 is mounted over the shaft 501 of a motor through the fasteners 508. The fastener 507 is used for fastening the two pins 505 over the sleeve 403. The fasteners 507,508 are passed through the holes provided at the cylindrical peripheral surface of the sleeve 403. The encoder wheel 404 is arranged after the axial sleeve 403 and mounted over the shaft 501 of the motor. The motor fixing plate 503 has a central hole to receive the shaft 501 of the motor. The motor is mounted on the base 504.

The cable 406 connected between the cable supports attached to the two holder supports in the roll and handle assembly is made to pass over the moving capstan 401 so that the moving capstan 401 is rotated and moved linearly (co-axially to motor shaft) when the roll and handle assembly is operated to move in any direction (translational degree of freedom) while keeping it at any angle (3 rotational degree of freedom yaw, roll and pitch). When the moving capstan 401 is rotated, the sleeve 403 is also rotated along with it thereby rotating the shaft 501 of the motor. The rotation speed of the motor is detected and measured by the encoder wheel 404.

The moving capstan drive mechanism is also rotated by rotating the motor to provide a force feedback to the user when the haptic device is operated. A virtual reality environment software generates a feedback force signal which is transmitted to an actuator to drive the moving capstan drive mechanism 401 to provide a haptic force feedback to the user, when a vocational hand tool is operated.

With respect to FIG. 6, the haptic device 500 consists of an actuator shaft 501, a moving capstan 401, a sleeve 403, a cable 406 and a circular rod 503. The moving capstan 401 consists of inner thread mounted on a screw 402. The screw 402 is fixed on one end to an immovable supporting frame 502. Supporting frame 502 is made immovable by fixing it by means of screws 505 over a base 504. Supporting frame 502 is moved and adjusted by means of guided key 506 to keep the whole moving capstan assembly in line with the motor shaft 501. The moving capstan 401 has external thread on the outer surface. The moving capstan 401 has two through holes which are arranged in parallel to and at equal spacing from the cylindrical axis. The inner and outer threads of the moving capstan 401 are of same pitch. The sleeve 403 is fixed to the encoder 404 and to the motor shaft 501 by means of screws 5087. The sleeve 403 consists of two pins 405. The two pins 405 are aligned to the moving capstan holes and are arranged in parallel to and at equal spacing from the cylindrical axis. The two pins 405 have a sliding fit with the moving capstan. The two pins 405 are rigidly attached to the sleeve 403 by means of the screws 507. The cable is wound over the outer thread of moving capstan 401. The cable 406 is fixed at both ends to the holder. The motor is fixed rigidly over a motor fixing plate 503 using screws. Motor fixing plate 503 is fixed over base 504 using screws

The user moves the tool handle by exerting a mechanical force on the tool handle. Since the tool handle is fastened to a holder, the holder moves along the guided linear path by means of guide and rail. While the holder is moved in a linear path as the cable 406 is fixed to the holder, the cable 406 rotates the floating moving capstan 401. As the floating moving capstan 401 is free to rotate/move over the screw 405, the moving capstan 401 rotates and also moves axially. Moving capstan 401 can be moved axially any direction according to the forward and reverse movement of the cable 406. The moving capstan 401 rotates the two pins 405 along with it, when it rotates and moves axially. Hence the rotational movement of floating moving capstan 401 is transferred to pins 405. The axial movement of the floating drum 401 is not transferred to pins 405 as the drum 401 slides over the pins 405. The rotation of pins 405 in turn rotates the sleeve 403 fastened to the pins 405. The sleeve 403 in turn rotates the motor shaft 501. Further the rotational movement of the motor shaft 501 leads to a helical movement of the moving capstan 401. The moving capstan 401 in turn moves the holder in a linear path by the guide and rail system assembly. Since the holder is fastened to the handle of the haptic device, the human hand holding the holder experiences the feedback force.

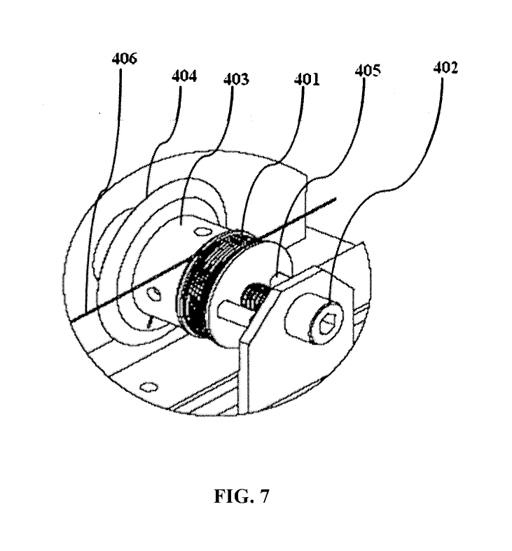

FIG. 7 illustrates a perspective view of a moving capstan drive mechanism in a moving capstan assembly in a system for delivering haptic force feedback, according to an embodiment of the present invention. With respect to FIG. 7, the moving capstan 401 consists of inner thread mounted on a screw 402. The screw 405 is fixed at one end to an immovable supporting frame. The moving capstan 401 has external threads on the outer surface. The moving capstan 401 has two through holes arranged in parallel to and at equal spacing from the cylindrical axis. The sleeve 403 is fixed to the encoder 404 by means of screws. The sleeve 403 consists of two pins 405. The two pins 405 are aligned to the floating drum holes and are arranged in parallel to and at equal spacing from the cylindrical axis. The two pins 405 have a sliding fit with the floating drum holes. The two pins 405 are rigidly attached to sleeve 403 by means of screws. A cable 406 is wound over the outer thread of moving capstan 401.

As the moving capstan 401 is free to rotate/move (co-axially) over the screws 405, the moving capstan 401 rotates and also moves co-axially. Moving capstan 401 can move axially any direction (sideways) according to the forward and reverse movement of the roll and handle assembly. The moving capstan 401 rotates the two pins 405 along with it, when the moving capstan 401 rotates and moves co-axially. Hence the rotational movement of the moving capstan 401 is transferred to the pins 405. The axial movement of the moving capstan 401 is not transferred to the pins 405 as the moving capstan 401 slides over the pins 405, in turn it leads no sideways movement for cable and thereby reducing the slackening or over tensioning of the cable 406 in the absence of the supporting arm. The rotation of the pins 405 in turn rotates the sleeve 403 fastened to the pins 405.

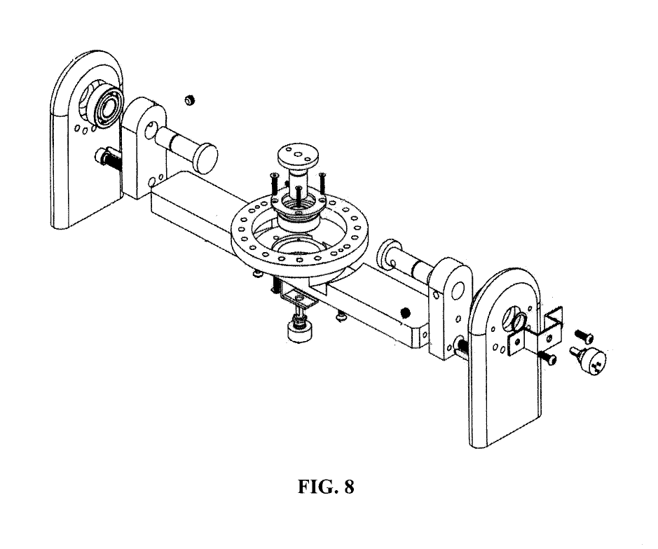

FIG. 8 illustrates an exploded perspective view of a yaw and pitch assembly in a system for delivering haptic force feedback, according to an embodiment of the present invention. With respect to FIG. 8, a yaw assembly comprises two vertical outer supports, two vertical inner supports, a ring support platform, a ring, a vertical shaft and a two potentiometer one each for yaw and pitch rotation. The yaw assembly has a ring support platform mounted with a ring. The support platform has a groove to receive and hold the rotatable ring. The ring is attached to the ring support platform. The base supports roll and handle assembly along with the moving capstan drive mechanism.

A vertical shaft is attached to the base. The vertical shaft is received in a central hole provided in the of the ring support platform and is fastened to the ring support platform through a bush and a bearing arrangement. The ring support platform is fixed between two vertical inner supports. The two distal ends of the ring support platform are fixed to the two vertical inner support platforms through fasteners. The fasteners include a screw. The two vertical inner supports are connected to two vertical outer supports through two set of pins and bearings. The length of the two vertical outer supports is more than the length of the two vertical inner supports so that the ring support platform is hung from the two outer vertical supports. Two potentiometers are attached to the yaw and pitch assembly. One potentiometer is attached to the bottom of the ring support platform for sensing the yaw rotation and another potentiometer is attached to one of the vertical outer supports from outside. The potentiometer assembly includes a potentiometer attached to the ring support platform and any one of the vertical outer supports using two angled frames. The angled frame has a strip bent twice at right angles to form an S-shaped frame. Both the distal ends of the angled frame are bent at right angles in opposite directions. One end of the angled frame is connected to the bottom of the ring support platform through a fastener while the other end of the angled frame is attached to the potentiometer shaft to measure a yaw rotation. In the same way, one end of angle frame is attached to a vertical outer support and another end is attached to the potentiometer shaft to measure a pitch rotation. The potentiometer is used for measuring the yaw rotation and pitch rotation.

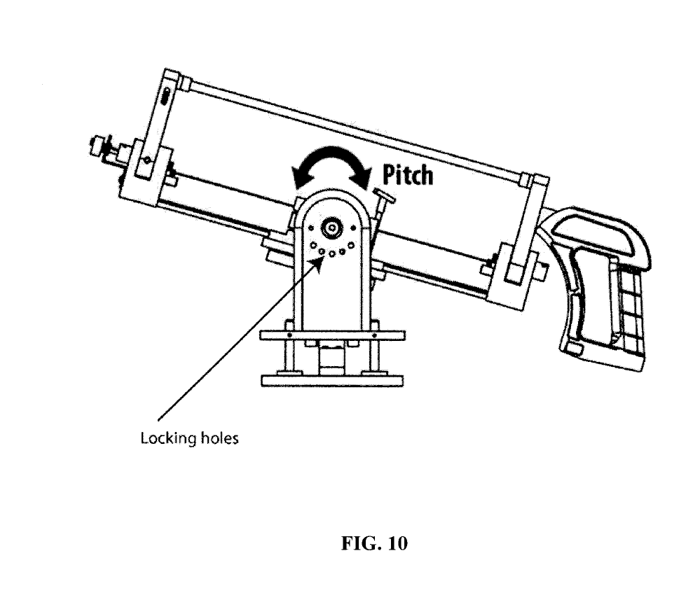

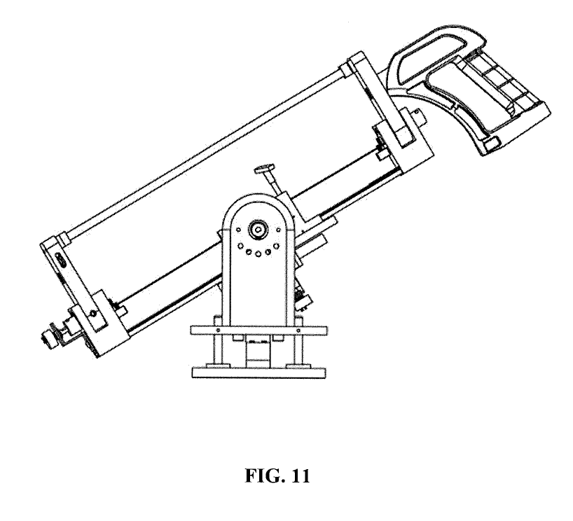

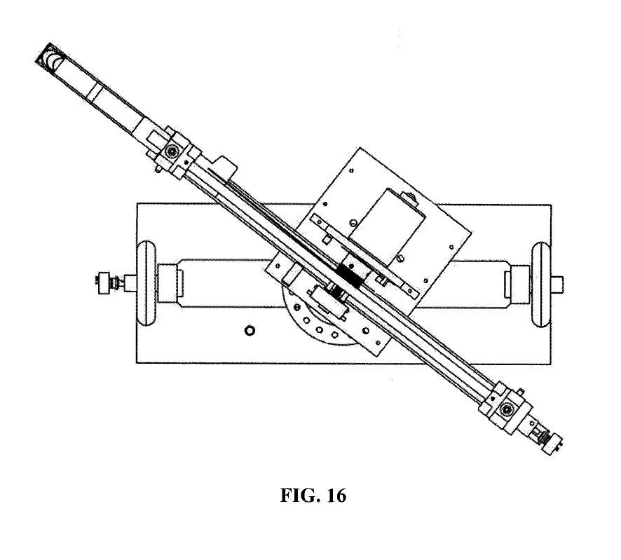

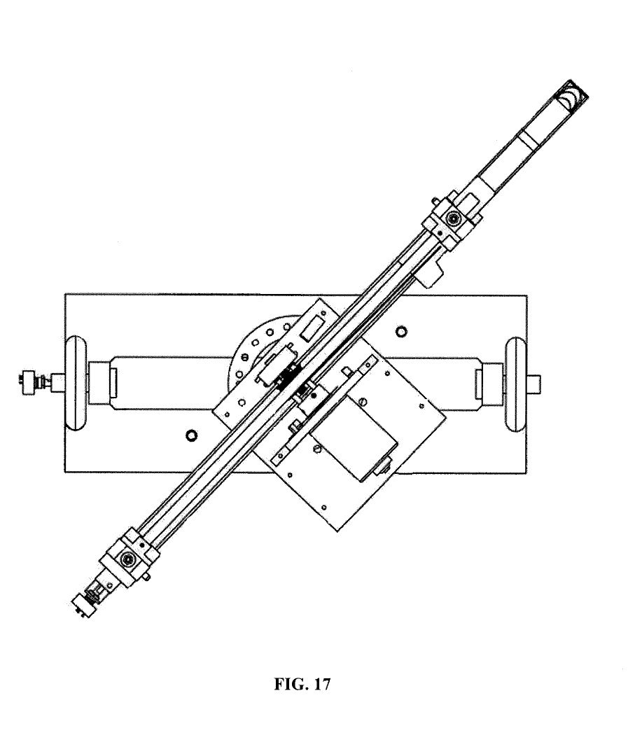

The yaw and pitch assembly is provided to vary the pitch, yaw and roll angle of the movement of the roll and handle assembly. The roll and handle assembly is rotatably moved over the ring platform so that the handle in the roll and handle assembly is arranged in a position as shown in FIG. 16 or in a position as shown in FIG. 17. To get a yaw rotation. Yaw rotation can be continuous or can be moved to a specific angle and where as it can be secularly locked by means of locking pin. The roll and handle assembly is rotatable moved over the over two set of pins which connects the inner support and outer support of yaw and pitch assembly so that the pitch rotation can be executed in the roll and handle assembly as arranged in a down position as shown in FIG. 10 or in an upward position as shown in FIG. 11. The movement can be continuous to get a pitch rotation (rotational degree of freedom) or can be moved to any specific angle and be locked secularly at that angular position by means of locking pins

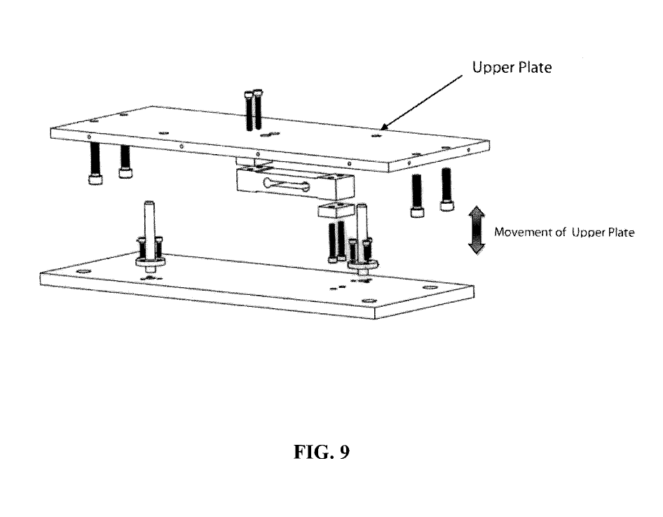

FIG. 9 illustrates an exploded perspective view of a load cell assembly in a system for delivering haptic force feedback, according to an embodiment of the present invention. With respect to FIG. 9, a load cell assembly comprises an upper plate, a lower plate and a load cell mechanism. The load assembly has a load cell mechanism arranged between two rectangular plates. The two rectangular plates include an upper plate and a lower plate. One end of the load cell mechanism is connected to the upper plate through a fastener while the other end of the lead cell mechanism is connected to the bottom plate through another fastener. The fastener includes a washer and a nut and bolt arrangement. The upper plate and the lower plate are attached to each through a securing means. The securing means include a nut and bolt arrangement, threaded screws, guide pins, etc. The load cell assembly is arranged below the yaw and pitch assembly to measure the load applied using the roll and handle assembly. The two outer vertical supports of the yaw and pitch assembly are mounted and attached to the upper plate in the load cell assembly. Upper plate will move down while a load is applied by means of tool handle and holders in the roll and handle assembly. The upper plate is guided by two pins and free movement on vertical direction either upward or downward. When the load is applied, upper plate moves down and the shear experienced by the load cell produces a proportional analog voltage signal which is amplified using an amplifier circuit and transmitted to the information processor.

The load cell assembly is arranged below the yaw assembly to measure the load or torque applied using the roll and handle assembly. The two outer vertical supports of the yaw assembly are mounted and attached to the upper plate in the load cell assembly.

The process of working of the haptic device is as follows: The sensor mounted on the motor reads the rotation (in effect the position change of the handle). This is transmitted from the sensor via the sensing circuit to the microcontroller (uC) on board the device. The uC then transmits this data to the computer and is inputted to the VR application running on it. In the VR application, this position change causes a interaction between the 3D objects in the application. This interaction will cause a haptic force feedback to be rendered (based on algorithms). This haptic force feedback value is scaled accordingly and transmitted back to the uC which is then sent to the control circuit. The control circuit provides a control signal to the motor based on the force feedback signal it receives and the force feedback signal drives the motor, which then provides the haptic force feedback.

### ADVANTAGES OF THE INVENTION

The various embodiments herein provide a mechanism for delivering haptic force feedback in a haptic device. The system and method for delivering a haptic force feedback prevents a slackening or (tightening) over tensioning of the cable in the force-torque transfer in the absence of a base for the cable. The cable is tensed sufficiently by making the moving capstan to rotate as well as move co-axially to motor shaft (linearly). The cable wound on moving capstan need not be supported by a base in the novel system and method of delivering feedback force in a haptic device. The system and method for delivering haptic force feedback allows the moving capstan moves co-axially to convert linear movement into rotational movement from holder to motor. Further a system and method for delivering haptic force feedback allows the moving capstan to move axially to convert a rotational movement from a motor into linear motion to a holder.

The haptic device along with multiple virtual reality interfaces and haptic rendering is designed to simulate multiple vocational hand tools using interchangeable handles. The mechanism is applied in the haptic devices using a cable wound on the moving capstan as an apparatus of force transfer to provide a translational degree of freedom. The haptic devices are used in industrial training institutes and virtual learning to provide personalized training to a large population of technicians.

The foregoing description of the specific embodiments herein will so fully reveal the general nature of the embodiments herein that others can, by applying current knowledge, readily modify and/or adapt such specific embodiments herein for various applications without departing from the generic concept, and, therefore, such adaptations and modifications should and are intended to be comprehended within the meaning and range of equivalents of the disclosed embodiments in the present invention. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the embodiments herein with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A system for delivering a haptic force feedback to a user during an operation of a vocational tool comprising:
Two holders;
a moving capstan drive mechanism connected to the two holders;
a motor connected to the moving capstan drive mechanism;
a sensor mounted on the motor shaft;
a control circuit connected to the sensor-motor;
a sensing circuit connected to the sensor; and
an information processor connected to the control circuit and sensing circuit;
wherein the moving capstan drive mechanism converts a helical movement of a moving capstan into a rotary movement by eliminating a transfer of linear movement to rotate a haptic device to get a kinesthetic force feedback, and wherein the moving capstan drive mechanism moves the moving capstan helically so that the moving capstan is rotated as well as moved coaxially to the motor to convert a linear movement of a tool handle in a handle and roll assembly into a rotational movement of motor and wherein the sensor outputs a signal based on the rotational movement of the motor to the information processor to provide a haptic feedback to a user, when the movable frame is displaced linearly by the user.

2. The system according to claim 1, wherein the information processor is loaded with a virtual reality environment software to provide a force feedback to the user, when the movable frame is displaced, and wherein the information processor computes a position information of the motor shaft and provides a force feedback signal using the virtual reality environment software.

3. The system according to claim 1, wherein a cable is connected between two distal ends of the holder and wherein the cable is passed and wound over the moving capstan drive mechanism.

4. The system according to claim 1, wherein the moving capstan mechanism comprises a moving capstan and wherein the cable is passed and wound over the moving capstan.

5. The system according to claim 1, wherein the moving capstan is connected to sleeve by means of two pins.

6. The system according to claim 1, wherein the sleeve is coupled to a shaft of the motor.

7. The system according to claim 1 further comprises a tool handle connected to roll and handle assembly.

8. The system according to claim 1, wherein the moving capstan is rotated and as well moved co-axially to motor shaft.

9. The system according to claim 1, wherein the holder is displaced linearly to move along with the cable wound on the moving capstan to rotate and move the moving capstan co-axially to motor shaft linearly to rotate the sleeve in turn to rotate the motor.

10. The system according to claim 1, wherein the sensor detects the rotation of the motor and outputs a position change information signal based on the rotational movement of the motor to the information processor to effect a change in the position of the virtual device in the virtual environment.

11. The system according to claim 1, further comprises a yaw and pitch assembly connected to the base to vary, pitch, yaw angle of a tool handle connected to roll and holder assembly.

12. The system according to claim 1 further comprises a load cell assembly mounted below the yaw and pitch assembly to detect a vertical force applied during a movement of the tool handle.

13. A method for delivering a haptic force feedback to a user during an operation of a hand tool comprises:
Connecting a tool handle to the one holder or two holders
connecting a holder to a moving capstan mechanism;
coupling an actuator (motor) to the moving capstan mechanism;
arranging a sensor to detect a rotational movement of the motor;
arranging sensors to detect rotation in the yaw, pitch and roll axes and communicatively connecting an information processor to the sensors to receive an output of the sensors;
providing a haptic feedback based on the received output of the sensor; and
displaying a result of a tool operation of a user on a monitor using the information processor;
wherein the moving capstan is displaced linearly to rotate and move the moving capstan drive mechanism to rotate the motor and the sensor detects the rotational movement to output a signal to the control circuit to provide a haptic feedback to a user, when the user displaces the holder.

14. The method according to claim 13, wherein a cable is connected between two distal ends of the holder and wherein the cable is passed and wound over the moving capstan mechanism.

15. The method according to claim 13, wherein the moving capstan mechanism comprises a moving capstan and wherein the cable is passed and wound over the moving capstan.

16. The method according to claim 13, wherein the moving capstan is connected to a sleeve.

17. The method according to claim 13, wherein the sleeve is coupled to a shaft of the motor.

18. The method according to claim 13 further comprises a tool connected to the moving capstan mechanism.

19. The method according to claim 13, wherein the moving capstan is rotated and as well moved linearly.

20. The method according to claim 13, wherein the movable frame is displaced linearly to move the cable wound on the moving capstan to rotate and move the moving capstan linearly to rotate the axial shaft to rotate the motor.

21. The method according to claim 13, wherein the sensor detects the rotation of the motor and outputs a signal based on the rotation of the motor to the information processor which in turn provides a signal, based on a force feedback algorithm to the control circuit to provide a haptic feed back to the user.

22. A system for delivering a haptic force feedback to a user during an operation of a hand tool comprising:
a base;
a roll and handle assembly mounted on the base;
a moving capstan assembly connected to the roll and handle assembly;
a moving capstan drive mechanism provided in the moving capstan assembly;
a yaw and pitch assembly arranged below the base;
a load cell assembly provided below the yaw and pitch assembly;
a sensor assembly;
a control circuit;
an information processor; and
wherein the roll and handle assembly is moved linearly to rotate and move the moving capstan mechanism to rotate a motor drive; and wherein the sensor assembly detects the rotation of the motor to output a signal to a control circuit to provide a haptic feed back through the information processor, and wherein the roll and handle assembly also provides roll rotation.

23. The system according to claim 22, wherein the information processor is provided with software to generate a virtual environment to provide a haptic force feedback to a user based on a force feedback algorithm through the control circuit, when the roll and handle assembly is operated.

24. The system according to claim 22, wherein the roll and handle assembly is moved in any angle in upwards, sideways and downwards, and wherein the roll and handle assembly is continuously moved to specific angle in yaw, pitch and roll within limits and locked by means of locking pins.

25. The system according to claim 22, wherein the yaw and pitch is assembly is provided to vary the pitch, yaw and angle of the movement of the roll and handle assembly.

26. The system according to claim 22, wherein the load cell assembly detects the vertical force applied during the movement of the roll and handle assembly.

27. The system according to claim 22, wherein the roll and handle assembly comprising:
two holders are connected by circular rod at top and by a rail at bottom;
a linear rail mounted on the base and arranged between the two holder supports;
two roll rotation plates mounted on the two holders respectively;
a circular rod connected between the two roll rotation plates;
a handle is connected to one of the two roll rotation plate or connected to both roll rotation plates depends on the requirement.
two cable supports mounted on a side surface in the two holders respectively; and
a cable connected between the two cable supports.

28. The system according to claim 22, wherein the moving capstan assembly comprising:
one immovable frame and one motor fixing plate mounted on the base;
a screw is fixed to immovable frame;
a moving capstan is moved over the screw;
an sleeve coupled to the moving capstan by means of two pins a motor coupled to the sleeve through a shaft; and
an encoder wheel mounted behind the sleeve;
wherein the cable connected between the cable supports attached to the two holders in the roll and handle assembly is made to pass over the moving capstan so that the moving capstan is rotated and moved co-axially to motor shaft linearly when the roll and handle assembly is operated to move in any direction keeping it at any angle and wherein the sleeve is also rotated along with it by means of two pins thereby rotating the shaft of the motor, when the moving capstan is rotated and wherein the rotation speed of the motor is detected and measured by the encoder wheel.

29. The system according to claim 22, wherein the yaw and pitch assembly comprising:
two vertical outer supports;
two vertical inner supports pivoted by means of two set of pin and bearing to the two vertical outer supports;
a ring support platform is mounted between the two vertical inner supports;
a ring mounted on the ring support platform to lock the yaw assembly at given specific angles by means of locking pins;
a vertical shaft attached to the ring support platform and to the base;
a potentiometer is attached to the bottom of the ring support platform;
wherein the roll and handle assembly is rotatably moved over the ring platform so that the handle in the roll and handle assembly is arranged in a left handed position or in a right handed position to gets a yaw rotation.

30. The system according to claim 22, wherein the load cell assembly comprising:
an upper plate, and wherein the upper plate is guided by two pins and free to move in vertical direction either upward or downward;
a lower plate; and
a load cell mechanism arranged between the upper plate and the lower plate to measure the load applied when a hand tool is operated using the roll and handle assembly.

31. The system according to claim 22, wherein the information processor has a local controller to read the output signal from the sensor assembly and to provide an actuation signal to a motor drive control circuit to drive a motor to rotate the moving capstan to provide a force feedback to the user, when a hand tool connected to the roll and handle assembly is operated.
